(19) United States
(12) Patent Application Publication
(10) Pub. No.: US 2026/0225726 A1
(43) Pub. Date: Aug. 6, 2026

(54) PROPULSION SYSTEM

(71) Applicant: HITACHI, LTD., Tokyo (JP)

(72) Inventors: Ryouichi TAKAHATA, Tokyo (JP); Daisuke SATOU, Tokyo (JP); Yuuki OHNO, Tokyo (JP); Shun ENDO, Tokyo (JP); Tetsuya KAWASHIMA, Tokyo (JP)

(21) Appl. No.: 19/152,506

(22) PCT Filed: Apr. 22, 2024
(86) PCT No.: PCT/JP2024/015748

§ 371 Date: Jul. 31, 2025

(30) Foreign Application Priority Data
May 17, 2023 (JP) 2023-081523

(51) Int. Cl. B64D 33/10; B64D 27/34

(52) U.S. Cl. CPC B64D 33/10; B64D 27/34

(57) ABSTRACT

A propulsion system according to the present invention comprises: a plurality of motors which rotate propellers of an electrical aircraft; a plurality of inverters which supply power to the motors; a plurality of refrigerant pipings through which a refrigerant for cooling the motors and the inverters flows; pumps which are connected to the refrigerant pipings and which send out the refrigerant; radiators which are connected to the refrigerant pipings and which discharge heat of the refrigerant; first switches which switch one of the refrigerant pipings through which the refrigerant flows; and a control unit which controls the first switches. There are a plurality of refrigerant pipings through which the pumps and the radiators are connected, and the control unit switches and controls the first switches when the pressure of the refrigerant in the refrigerant pipings deviates from a normal range.

### TECHNICAL FIELD

The present invention relates to a propulsion system.

### BACKGROUND ART

From the recent trend of CO₂ reduction, CO₂ emission regulations are strongly required in each country for realizing a zero-carbon society. As an alternative to an engine using fossil fuel that emits CO2, electrification that does not emit CO₂ during operation of a power system has been actively promoted. Therefore, in every engine-driven mobility product, it is required to improve the output density for future power electronics equipment.

Therefore, it is essential to be able to cope with any climate in the world and to have environmental resistance capable of coping with rapid altitude changes in the aircraft. At the same time, there is a demand for technical measures for improving cooling performance, increasing voltage, reducing weight, and the like.

PTL 1 discloses a cooling circuit that cools an electric component group in order to maintain performance in an aircraft including the electric component group that drives a rotor that generates lift or thrust of the aircraft.

PTL 1 discloses a cooling system (60) including a rotor (20) that generates at least one of lift and thrust of an aircraft (10), a component group (24) including a plurality of electric components that rotates the rotor (20), and a cooling circuit (62) that cools the component group (24). The cooling system (60) includes a plurality of component groups (24) corresponding to a plurality of the rotors (20), and the plurality of component groups (24) are cooled by the same cooling circuit (62). That is, an object of PTL 1 is to provide a simple and light cooling system.

### CITATION LIST

### Patent Literature

PTL 1: JP 2022-157295 A (FIG. 1, FIG. 2, FIG. 3, FIG. 9, Paragraphs 0055 to 0064, and the like)

### SUMMARY OF INVENTION

### Technical Problem

However, in the above-described conventional technique, when all the rotors (20) are driven, in a case where an electrical system or a mechanical system related to one rotor (20) has failed, yaw moment (force for rotating) is generated in a body, and thus it is necessary to stop one normal rotor (20) paired with the failed rotor (20).

Further, when two rotors (20) forming a pair are stopped, one independent cooling system including the two rotors (20) is also stopped. Therefore, there is a concern that this causes degradation in redundancy and cooling performance for a propulsion system.

The present invention has been made in view of the above circumstances, and an object of the present invention is to provide a propulsion system that suppresses degradation in redundancy and cooling performance.

### Solution to Problem

In order to solve the above problems, a propulsion system according to the present invention includes: a motor that rotates a propeller of an electrical aircraft; an inverter that supplies power to the motor; a refrigerant piping through which a refrigerant for cooling a plurality of the motors and a plurality of the inverters flows; a pump that is connected to the refrigerant piping and sends out the refrigerant; a radiator that is connected to the refrigerant piping and discharges heat of the refrigerant; a first switch that performs switching to any one of a plurality of the refrigerant pipings through which the refrigerant flows; and a control unit that controls the first switch, in which the plurality of the refrigerant pipings connecting the pump and the radiator are provided, and the control unit performs switching control of the first switch in a case where pressure of the refrigerant in the refrigerant piping deviates from a normal range.

ADVANTAGEOUS EFFECTS OF INVENTION

According to the present invention, it is possible to provide a propulsion system that suppresses degradation in redundancy and cooling performance.

### BRIEF DESCRIPTION OF DRAWINGS

FIG. 1 is a schematic plan view of an electrical aircraft including a propulsion system according to a first embodiment of the present invention as viewed from above.

FIG. 2 is a schematic view of a part of a cooling circuit of the propulsion system according to the first embodiment of the present invention.

FIG. 3 is a schematic view of the cooling circuit of the propulsion system according to the first embodiment.

FIG. 4A is a schematic view of a cooling circuit of a propulsion system in a comparative example (conventional).

FIG. 4B is a schematic view of a cooling circuit of a propulsion system in a comparative example (conventional).

FIG. 4C is a schematic view of a cooling circuit of a propulsion system in a comparative example (conventional) .

FIG. 5 is a schematic view of a cooling circuit of a propulsion system according to a second embodiment.

### DESCRIPTION OF EMBODIMENTS

Embodiments of the present invention will be appropriately described below in detail with reference to the drawings.

### First Embodiment

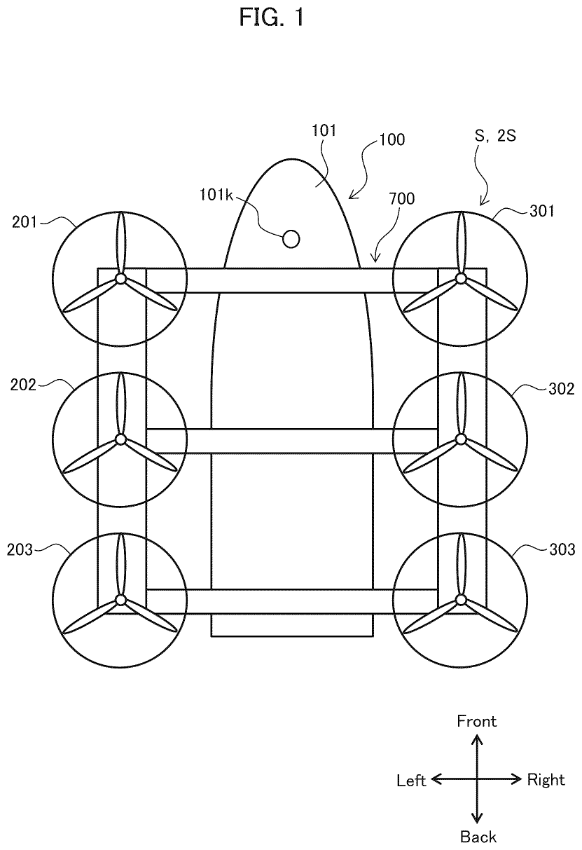

A propulsion system S according to a first embodiment of the present invention will be described with reference to FIGS. 1 to 3.

FIG. 1 illustrates a schematic plan view of an electrical aircraft 100 including the propulsion system S according to the first embodiment of the present invention as viewed from above.

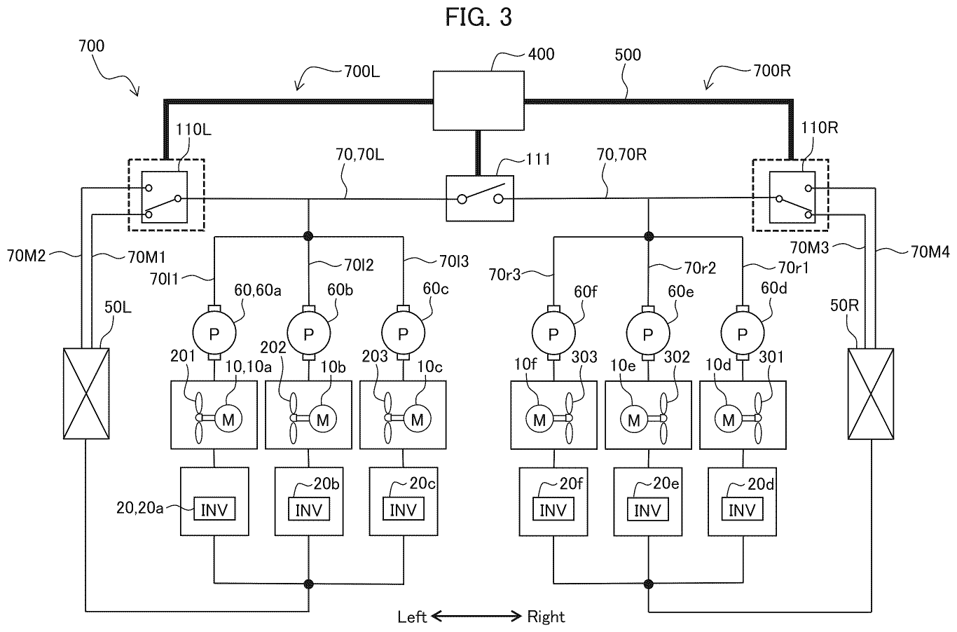

As the propulsion system S according to the first embodiment, an electrical aircraft 100 whose drive source is a motor 10 (see FIG. 3) is assumed.

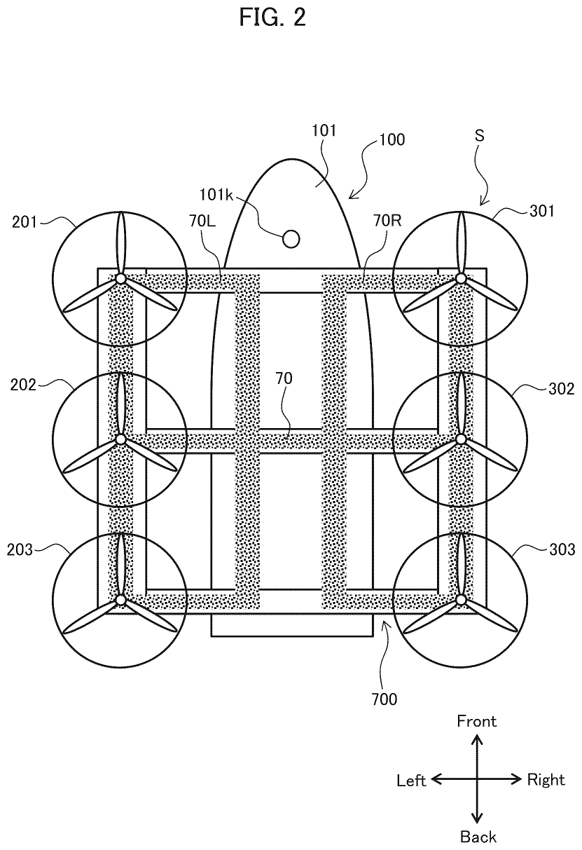

FIG. 2 illustrates a schematic view of a part of a cooling circuit of the propulsion system S according to the first embodiment of the present invention.

FIG. 3 illustrates a schematic view of the cooling circuit of the propulsion system S according to the first embodiment.

The electrical aircraft 100 to which the propulsion system S illustrated in FIG. 1 is applied drives propellers 201 to 203 (see FIG. 1) and 301 to 303 by using an inverter 20 (see FIG. 3) that supplies power to the motor 10, and generates thrust.

The electrical aircraft 100 takes off with an increased output at the time H take-off. Thereafter, when the electrical aircraft 100 ascends to a predetermined altitude, the electrical aircraft flies at a cruising speed. An altimeter 101k (see FIG. 1) is provided in a cockpit of the electrical aircraft 100 to measure altitude.

As illustrated in FIG. 2, the electrical aircraft 100 includes a fuselage (body) 101, propellers 201, 202, and 203 on the left side of the fuselage 101, and propellers 301, 302, and 303 on the right side of the fuselage 101.

An electric system (power component) for driving the left propellers 201 to 203 and the right propellers 301 to 303 includes a motor 10 (10a to 10f) and an inverter 20 (20a to 20f). The inverter 20 (20a to 20f) converts DC power of a power source into AC power, and supplies a drive current to the motor 10 (10a to 10f).

The inverter 20 includes a plurality of power semiconductor elements (not illustrated) and a control circuit (not illustrated) that controls the power semiconductor elements. The inverter 20 is connected to a power storage device (not illustrated) as the power source. The inverter 20 converts DC power from the power storage device into AC power suitable for the motor 10 (10a to 10f).

The power storage device includes, for example, a capacitor or a secondary battery such as a lithium ion battery or a nickel hydrogen battery. Power is exchanged between the power storage device and the motor 10 via the inverter 20 (see FIG. 3).

The rotational torque generated by the motor 10 is transmitted to the propellers 201, 202, 203, 301, 302, and 303 via a speed reducer (not illustrated) and a differential device (not illustrated). As a result, the propellers 201, 202, 203, 301, 302, and 303 of the electrical aircraft 100 illustrated in FIG. 1 rotate, and the body (fuselage 101) cruises.

The inverter 20 illustrated in FIG. 3 controls the motor 10 to generate a torque output or generated power according to a command based on a torque command from an integrated control device (not illustrated).

A control circuit of the inverter 20 controls a switching operation of the power semiconductor element based on a command from the integrated control device (not illustrated). The motor 10 is operated as an electric motor by the switching operation of the power semiconductor element.

In a case where the motor 10 is operated as an electric motor, DC power from the power storage device is supplied to a DC terminal of the inverter 20. The control circuit of the inverter 20 controls the switching operation of the power semiconductor element to convert DC power into three-phase AC power, and supplies the three-phase AC power to the motor 10. Note that the motor 10 according to the first embodiment is an interior permanent magnet three-phase synchronous motor.

A cooling system 700 (700L and 700R) of the propulsion system S cools the motor 10 and the inverter 20 that become hot by operation.

Therefore, the cooling system 700 illustrated in FIG. 3 includes a refrigerant piping 70 through which a refrigerant flows, a pump 60, and radiators 50L and 50R.

The pump 60 is connected to the refrigerant piping 70 and sends out the refrigerant. The radiators 50L and 50R discharge heat of the refrigerant. In this manner, the refrigerant that flows through the refrigerant piping 70 of the cooling system 700 and is cooled cools the motor 10 and the inverter 20.

As illustrated in FIG. 2, the refrigerant piping 70 is provided so as to pass through the inside of the fuselage 101 as a refrigerant piping 70L on the left side of the fuselage 101 and a refrigerant piping 70R on the right side of the fuselage 101. That is, the refrigerant piping 70 constitutes the cooling system 700 divided into the left and right parts of the fuselage 101 that is the body.

The left cooling system 700L illustrated in FIG. 3 is connected to the radiator 50L via refrigerant pipings 70M1 and 70M2 and compensates for the abnormality of the refrigerant piping 70M1. The right cooling system 700R is connected to the radiator 50R via refrigerant pipings 70M3 and 70M4 and compensates for the abnormality of the refrigerant piping 70M3. As a result, the redundancy of the refrigerant pipings 70L and 70R is improved.

The radiator 50L cools the refrigerant flowing through the refrigerant piping 70L on the left side. The radiator 50R cools the refrigerant flowing through the refrigerant piping 70R on the right side.

### Cooling Circuit in Comparative Example (Conventional) and Cooling Circuit in First Embodiment

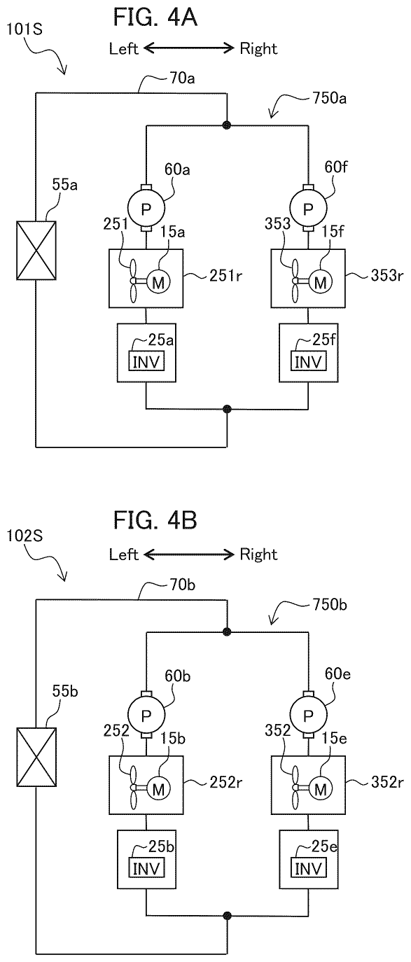

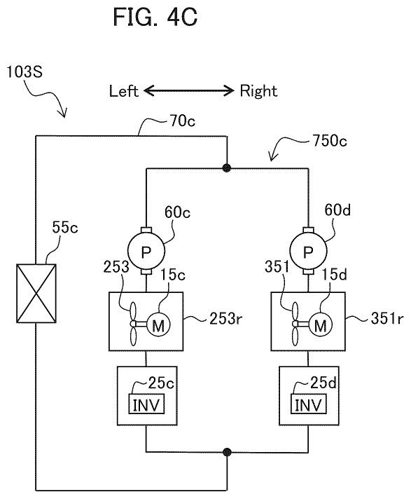

FIGS. 4A to 4C illustrate schematic views of cooling circuits of propulsion systems 101S, 102S, 103S in comparative examples (conventional), respectively.

The conventional propulsion systems 101S, 102S, and 103S illustrated in FIGS. 4A to 4C are interlocked with an electrical system and a mechanical system, and constitute cooling systems 750a, 750b, and 750c together with propellers 251 and 353 and propellers 252 and 352 and propellers 253 and 351 in pairs.

The cooling system 750a including an operation mechanism of the propeller 251 on the left side and an operation mechanism of the propeller 353 on the right side illustrated in FIG. 4A includes a radiator 55a for cooling a motor 15a and an inverter 25a on the left side and a motor 15f and an inverter 25f on the right side.

The cooling system 750b including an operation mechanism of the propeller 252 on the left side and an operation mechanism of the propeller 352 on the right side illustrated in FIG. 4B includes a radiator 55b for cooling a motor 15b and an inverter 25b on the left side and a motor 15e and an inverter 25e on the right side.

The cooling system 750c including an operation mechanism of the propeller 253 on the left side and an operation mechanism of the propeller 351 on the right side illustrated in FIG. 4C includes a radiator 55c for cooling a motor 15c and an inverter 25c on the left side and a motor 15d and an inverter 25d on the right side.

With the configuration described above, the cooling systems 750a, 750b, and 750c provide simple and light cooling systems.

However, in a case where the electrical system or the mechanical system associated with any one of rotors 251r and 353r illustrated in FIG. 4A has failed, yaw moment is generated in the body. Therefore, it is necessary to stop the other of the normal rotors 251r and 353r paired with any one of the failed rotors 251r and 353r.

Alternatively, in a case where the electrical system or the mechanical system associated with any one of rotors 252r and 352r illustrated in FIG. 4B has failed, yaw moment is generated in the body. Therefore, it is necessary to stop the other of the normal rotors 252r and 352r paired with any one of the failed rotors 252r and 352r.

Alternatively, in a case where the electrical system or the mechanical system associated with any one of rotors 253r and 351r illustrated in FIG. 4C has failed, yaw moment is generated in the body. Therefore, it is necessary to stop the other of the normal rotors 253r and 351r paired with any one of the failed rotors 253r and 351r.

Furthermore, since one independent cooling system 750a is also stopped as the two rotors 251r and 353r forming a pair illustrated in FIG. 4A are stopped, there is a concern that redundancy and cooling performance of the propulsion system 101S are degraded.

In addition, since one independent cooling system 750b is also stopped as the two rotors 252r and 352r forming a pair illustrated in FIG. 4B are stopped, there is a concern that redundancy and cooling performance of the propulsion system 102S are degraded.

In addition, since one independent cooling system 750c is also stopped as the two rotors 253r and 351r forming a pair illustrated in FIG. 4C are stopped, there is a concern that redundancy and cooling performance of the propulsion system 103S are degraded.

On the other hand, the cooling system 700L in the first embodiment illustrated in FIG. 3 includes the refrigerant piping 70L through which the refrigerant for cooling the plurality of motors 10a to 10c and the plurality of inverters 20a to 20c flows, the pumps 60a to 60c that are connected to the refrigerant piping 70L and send out the refrigerant, and the radiator 50L that is connected to the refrigerant piping 70L and discharges heat of the refrigerant.

That is, the refrigerant piping 70L through which the refrigerant sent out from the pumps 60a to 60c flows is connected to the plurality of motors 10a to 10c, the plurality of inverters 20a to 20c, and the radiator 50L. The plurality of motors 10a to 10c and the plurality of inverters 20a to 20c are cooled by the refrigerant flowing through the refrigerant piping 70L. The radiator 50L discharges the heat of the refrigerant.

In addition, the cooling system 700R in the first embodiment includes the refrigerant piping 70R through which the refrigerant for cooling the plurality of motors 10d to 10f and the plurality of inverters 20d to 20f flows, the pumps 60d to 60f that are connected to the refrigerant piping 70R and send out the refrigerant, and the radiator 50R that is connected to the refrigerant piping 70R and discharges heat of the refrigerant.

That is, the refrigerant piping 70R through which the refrigerant sent out from the pumps 60d to 60f flows is connected to the plurality of motors 10d to 10f, the plurality of inverters 20d to 20f, and the radiator 50R. The plurality of motors 10d to 10f and the plurality of inverters 20d to 20f are cooled by the refrigerant of the refrigerant piping 70R. The radiator 50R discharges the heat of the refrigerant.

Furthermore, in the cooling system 700L in the first embodiment, a plurality of refrigerant pipings 7011, 7012, and 7013 that connect the pumps 60a to 60c and the radiator 50L, respectively, are provided.

Note that pressure gauges are provided on a suction side and a discharge side of each of the pumps 60a to 60c, respectively. The pressure gauge is connected to a control unit 400, and detection value information of the pressure gauge is transmitted to the control unit 400.

In addition, in the cooling system 700R in the first embodiment, a plurality of refrigerant pipings 70r1, 70r2, and 70r3 that connect the pumps 60d to 60f and the radiator 50R, respectively, are provided.

Note that pressure gauges are provided on a suction side and a discharge side of each of the pumps 60d to 60f, respectively. The pressure gauge is connected to a control unit 400, and detection value information of the pressure gauge is transmitted to the control unit 400.

In addition, each of the pumps 60a to 60f is provided with a temperature sensor (not illustrated). In a case where any one of the radiators 50L and 50R has failed, the refrigerant is not cooled, so that the temperature of the pumps 60a to 60c or the pumps 60d to 60f on the failed side increases.

First Switches 110L and 110R and Second switch 111

As illustrated in FIG. 3, the cooling system 700L includes a first switch 110L that switches the refrigerant piping 70L through which the refrigerant flows to the refrigerant piping 70M1 and the refrigerant piping 70M2. Therefore, in a case where a piping abnormality has occurred in any one of the refrigerant piping 70M1 or the refrigerant piping 70M2 (in a case where the flow of the refrigerant deviates from a normal range), the first switch 110L performs switching to either the normal refrigerant piping 70Ml or 70M2.

In addition, the cooling system 700R includes a first switch 110R that switches the refrigerant piping 70R through which the refrigerant flows to the refrigerant piping 70M3 and the refrigerant piping 70M4. Therefore, in a case where a piping abnormality has occurred in any one of the refrigerant piping 70M3 or the refrigerant piping 70M4 (in a case where the flow of the refrigerant deviates from a normal range), the first switch 110R performs switching to any one of the normal refrigerant piping 70M3 or 70M4.

The cooling system 700 of the propulsion system S includes the control unit 400 that controls the first switch 110L and the first switch 110R.

In addition, a second switch 111 is connected between the refrigerant piping 70R and the refrigerant piping 70L. In a case where any one of the left and right radiators 50R and 50L has failed, the second switch 111 connects the refrigerant piping 70R and the refrigerant piping 70L to allow the cooled refrigerant to flow into the piping on the failed side. Note that, when the refrigerant flows into the piping on the failed side, the pumps 60a to 60c or the pumps 60d to 60f on the failed side are stopped. Alternatively, a configuration in which a valve (not illustrated) connecting the downstream side of the refrigerant piping 70R and the downstream side of the refrigerant piping 70L is provided, and the valve is connected only in a case where any one of the left and right radiators 50R and 50L has failed may be made.

Furthermore, the control unit 400 controls the first switches 110L and 110R based on the pressure of the refrigerant in the refrigerant piping 70L and the pressure of the refrigerant in the refrigerant piping 70R. That is, the control unit 400 controls the first switches 110L and 110R based on whether the pressure of the refrigerant in the refrigerant piping 70L and the pressure of the refrigerant in the refrigerant piping 70R are within the normal ranges.

For example, in a case where the pressure on the suction side of at least one of the pumps 60a to 60c deviates from the normal range and falls, or in a case where at least one of the temperature of each of the motors 10a to 10c, the temperature of each of the inverters 20a to 20c, and the temperature of each of the pumps 60a to 60c deviates from the normal range and rises, the control unit 400 determines that an abnormality has occurred in the refrigerant piping 70M1 and switches the first switch 110L to the refrigerant piping 70M2 side.

For example, in a case where an abnormality has occurred in the refrigerant piping 70M1, it becomes difficult to cool the refrigerant. Thus, at least one of the temperature of each of the motors 10a to 10c, the temperature of each of the inverters 20a to 20c, and the temperature of each of the pumps 60a to 60c deviates from the normal range and rises. Therefore, the first switch 110L is switched to the refrigerant piping 70M2 side.

In a case where there is still no improvement, the second switch 111 is switched and the left cooling system 700L and the right cooling system 700R are connected. As a result, the temperature of each of the motors 10a to 10f, the temperature of each of the inverters 20a to 20f, and the temperature of each of the pumps 60a to 60f can be cooled to have normal values.

Similarly, in a case where an abnormality has occurred in the refrigerant piping 70M3, the first switch 110R is switched to the refrigerant piping 70M4 side. In a case where there is still no improvement, the second switch 111 is switched and the right cooling system 700R and the left cooling system 700L are connected.

In addition, for example, in a case where at least one of the pressures on the discharge side of the pumps 60a to 60c deviates from the normal range and rises, the control unit 400 determines that an abnormality has occurred in the refrigerant piping 70M1 and switches the first switch 110L to the refrigerant piping 70M2 side. In a case where there is still no improvement, the second switch 111 is switched and the left cooling system 700L and the right cooling system 700R are connected.

Alternatively, for example, in a case where at least one of the pressures on the suction side of the pumps 60d to 60f deviates from the normal range and falls, the control unit 400 determines that an abnormality has occurred in the refrigerant piping 70M3 and switches the first switch 110R to the refrigerant piping 70M4 side. In a case where there is still no improvement, the second switch 111 is switched and the right cooling system 700R and the left cooling system 700L are connected.

In a case where at least one of the pressures on the discharge side of the pumps 60d to 60f deviates from the normal range and rises, the control unit 400 determines that an abnormality has occurred in the refrigerant piping 70M3 and switches the first switch 110R to the refrigerant piping 70M4 side. In a case where there is still no improvement, the second switch 111 is switched and the right cooling system 700R and the left cooling system 700L are connected.

Alternatively, in a case where any one of the left and right radiators 50R and 50L has failed, the refrigerant piping 70L and the cooling system 700R are connected through the second switch 111.

In addition, the control unit 400 controls the second switch 111 based on the pressure of the refrigerant in the refrigerant pipings 70L and 70R. That is, the control unit 400 controls the second switch 111 depending on whether or not the pressure of the refrigerant in the refrigerant pipings 70L and 70R deviates from the normal range. Specifically, in a case where the pressure of the refrigerant in the refrigerant pipings 70L and 70R deviates from the normal range, the control unit 400 performs control to switch the second switch 111 to connect the refrigerant piping 70L and the refrigerant piping 70R.

For example, in a case where the pressure on the suction side of the pumps 60a to 60c illustrated in FIG. 3 has decreased and it is determined that the radiator 50R has failed, the second switch 111 is connected, and the cooling system 700L and the cooling system 700R are connected. As a result, the refrigerant of the cooling system 700R flows into the cooling system 700L, and the cooling system 700R can be alternatively operated by the cooling system 700L. Alternatively, the temperature of each of the motors 10a to 10f is detected by a temperature detection value of a thermistor provided in each of the motors 10a to 10f. In addition, the temperature of each of the inverters 20a to 20f is detected by the operating temperature of an IGBT (Insulated Gate Bipolar Transistor) provided in each of the inverters 20a to 20f. In addition, the temperatures of the pumps 60a to 60f are detected by a temperature sensor. Signal information of the temperature detection value of each of the motors 10a to 10f, operation signal information of the IGBT of each of the inverters 20a to 20f, and temperature information of each of the pumps 60a to 60f are input to the control unit 400.

In a case where at least any one of the temperature of each of the motors 10a to 10f, the temperature of each of the inverters 20a to 20f, and the temperature of each of the pumps 60a to 60f deviates from the normal range and becomes equal to or higher than a predetermined temperature, the control unit 400 determines that any one of the radiator 50R and the radiator 50L has failed and cannot be cooled. In this case, the control unit 400 connects the second switch 111, and causes the refrigerant to flow from any one of the cooling system 700L and cooling system 700R that have failed to any one of the cooling system 700L and cooling system 700R that have not failed. As a result, even in a case where any one of the radiator 50R and the radiator 50L has failed, cooling can be continued with any of the other radiator 50R and radiator 50L that do not fail. Note that a configuration in which the second switch 111 is connected in a case where there is no improvement even if the first switch 110R or the first switch 110L is switched may be made.

In addition, the refrigerant piping 70L and the refrigerant piping 70R are each provided with a temperature sensor (not illustrated). The temperature sensor measures the temperature of the refrigerant in the refrigerant piping 70L and the temperature of the refrigerant in the refrigerant piping 70R.

In a case where any one of the radiator 50R and the radiator 50L has failed, the temperature of the refrigerant on the failed side deviates from the normal range and rises. Therefore, the second switch 111 is connected to cool the refrigerant on the failed side by any one of the radiator 50R and the radiator 50L that do not fail. Also in this case, a configuration in which the second switch 111 is connected in a case where there is no improvement even if the first switch 110R or the first switch 110L is switched may be made.

In a case where the problem is not solved even if the first switch 110R or the first switch 110L is switched, the control unit 400 is preferably configured to issue an alarm so that the electrical aircraft 100 stops flying.

### Operation of Electrical Aircraft 100

The electrical aircraft 100 takes off with an increased output at the time of take-off. When the electrical aircraft 100 ascends to a predetermined altitude, the electrical aircraft flies at a cruising speed.

At the time of take-off of the electrical aircraft 100, a load is large, and thus, take-off is performed by increasing the driving number (drive speed) of a plurality of power component groups such as the motors 10a to 10f, the inverters 20a to 20f, and the pumps 60a to 60f.

During cruise of the electrical aircraft 100, the load is lower than a load at the time of take-off. Thus, the operation is performed by reducing the driving number (drive speed) of the plurality of power component groups such as the motors 10a to 10f, the inverters 20a to 20f, and the pumps 60a to 60f.

The control unit 400 switches the driving number (drive speed) of the plurality of power component groups such as the motors 10a to 10f, the inverters 20a to 20f, and the pumps 60a to 60f based on the load and the flight state. In addition, the control unit 400 controls the first switches 110L and 110R and the second switch 111 to control the amount of cooling refrigerant flowing in accordance with the operation states of the motors 10a to 10f, the inverters 20a to 20f, and the pumps 60a to 60f.

For example, the refrigerant pipings 70M1 and 70M3 are set to have large diameters so that a large amount of refrigerant flows. On the other hand, the refrigerant pipings 70M2 and 70M4 are set to have small diameters so that the refrigerant flows less. Using the first switches 110L and 110R, the refrigerant flows from the large refrigerant pipings 70M1 and 70M3 during take-off, and the refrigerant flows from the small refrigerant pipings 70M2 and 70M4 during cruise. Alternatively, the refrigerant pipings 70M1, 70M2, 70M3, and 70M4 are set to have the same diameter. At the time of take-off, the second switch 111 is disconnected, and the refrigerant cooled in the radiators 50L and 50R flows into the cooling systems 700L and 700R, respectively. During cruise, the operation of any one of the radiators 50L and 50R may be stopped, the cooling systems 700L and 700R may be connected by the second switch 111, and the refrigerant may be cooled by the operation of any one of the radiators 50L and 50R.

This eliminates wasteful energy consumption.

With the above configuration, in the electrical aircraft 100, the cooling systems 700L and 700R divided into the left and right parts of the body are used, and the refrigerant pipings 70L and 70R, the first switches 110L and 110R, the second switch 111, and the control unit 400 that controls these components are provided for compensating for the left and right parts.

Regardless of the switching of the first switches 110L and 110R and the second switch 111, control is performed such that the refrigerant flows into the refrigerant piping 70L of the cooling system 700L and the refrigerant piping 70R of another cooling system. Thus, the balance between the left and right parts of the body (fuselage 101) is obtained.

As a result, the cooling system 700 (700L and 700R) independent of the electric system and the machine system can be obtained. Thus, it is possible to secure redundancy of the propulsion system S and to suppress degradation in cooling performance.

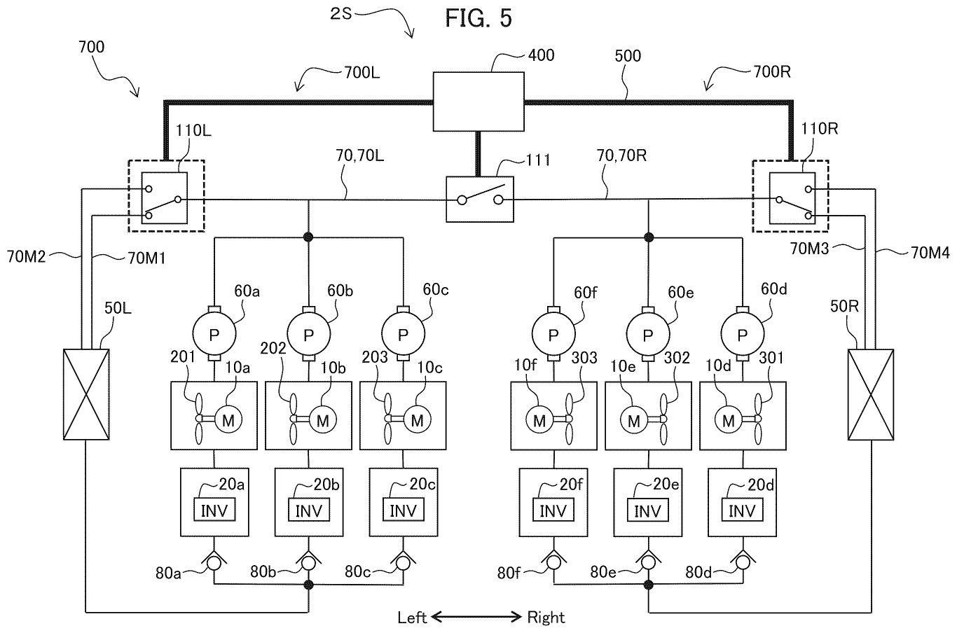

Second Embodiment FIG. 5 illustrates a schematic view of a cooling circuit of a propulsion system 2S according to a second embodiment.

The propulsion system 2S according to the second embodiment of the present invention will be described. Note that, in FIG. 5, the same or corresponding components as those of the first embodiment are denoted by the same reference signs, and differences will be described.

In the second embodiment, backflow prevention mechanisms 80a to 80f are provided on the discharge sides of the pumps 60a to 60f and the motors 10a to 10f and the inverters 20a to 20f as electric components, respectively. The backflow prevention mechanisms 80a to 80f are check valves, for example.

As a result, when the propellers 201 to 203 and 301 to 303 are stopped and started depending on the load of the fuselage 101 as the body or the flight state, it is possible to suppress an occurrence of a situation in which the refrigerant flows back through the pumps 60a to 60f due to the differential pressure between the suction side and discharge side of the pumps 60a to 60f.

Therefore, it is possible to improve the cooling performance of the cooling system 700 of the propulsion system 2S.

The backflow prevention mechanisms 80a to 80f may be provided inside the pumps 60a to 60f, respectively. Also in this case, it is possible to suppress the backflow of the refrigerant through the pumps 60a to 60f.

### Other Embodiments

1. Although the embodiments of the present invention have been described above, the above embodiments merely illustrate a part of the application example of the present invention, and the technical scope of the present invention is not intended to be limited to the specific configurations of the above embodiments.

The present invention is not limited to the configurations of the above-described embodiments, and various modifications and specific forms can be made within the scope of the appended claims.

REFERENCE SIGNS LIST
100 electrical aircraft
101 fuselage
10, 10a to 10f motor
20, 20a to 20f inverter
50L, 50R radiator
60, 60a to 60f pump
70L, 70R, 70M1, 70M2, 70M3, 70M4 refrigerant piping
80a to 80f backflow prevention mechanism
110L, 110R first switch (first switch)
111 second switch (second switch)
201, 202, 203, 301, 302, 303 propeller
400 control unit
700L, 700R cooling system
S, 2S propulsion system

1. A propulsion system comprising:
a motor that rotates a propeller of an electrical aircraft;
an inverter that supplies power to the motor;
a refrigerant piping through which a refrigerant for cooling a plurality of the motors and a plurality of the inverters flows ;
a pump that is connected to the refrigerant piping and sends out the refrigerant;
a radiator that is connected to the refrigerant piping and discharges heat of the refrigerant;
a first switch that performs switching to any one of a plurality of the refrigerant pipings through which the refrigerant flows; and
a control unit that controls the first switch, wherein
the plurality of the refrigerant pipings connecting the pump and the radiator are provided, and
the control unit performs switching control of the first switch in a case where pressure of the refrigerant in the refrigerant piping deviates from a normal range.

2. The propulsion system according to claim 1, wherein the refrigerant piping, the pump, and the radiator constitute a cooling system,
the refrigerant piping is connected to another cooling system through a second switch, and
the control unit performs switching to the second switch in a case where the pressure of the refrigerant in the refrigerant piping deviates from the normal range, and controls the refrigerant piping to be connected to the another cooling system.

3. The propulsion system according to claim 1, wherein
the refrigerant piping, the pump, and the radiator
constitute a cooling system, the refrigerant piping is connected to another cooling system through a second switch, and
the control unit performs switching to the second switch in a case where a temperature of the refrigerant in the refrigerant piping deviates from a normal range, and controls the refrigerant piping to be connected to the another cooling system.

4. The propulsion system according to claim 1, wherein
the refrigerant piping, the pump, and the radiator constitute a cooling system,
the refrigerant piping is connected to another cooling system through a second switch, and
the control unit controls the refrigerant to flow into the refrigerant piping of the cooling system and the refrigerant piping of the another cooling system regardless of switching between the first switch and the second switch.

5. The propulsion system according to claim 1, further comprising:
a temperature sensor that detects a temperature of each of the motor, the inverter, and the pump, wherein
the refrigerant piping, the pump, and the radiator constitute a cooling system,
the refrigerant piping is connected to another cooling system through a second switch, and
the control unit performs switching control of the first switch and the second switch based on a temperature of the motor, a temperature of the inverter, a temperature of the pump, and a temperature of the refrigerant in the refrigerant piping.

6. The propulsion system according to claim 1, wherein
the refrigerant piping, the pump, and the radiator constitute a cooling system,
the refrigerant piping is connected to another cooling system through a second switch,
the control unit controls the first switch and the second switch based on a load or a flight state, and
a driving number of the motor, the inverter, and the pump is switched.

7. The propulsion system according to claim 1, wherein
a backflow prevention mechanism is provided on a discharge side of the refrigerant piping.

8. The propulsion system according to claim 1, wherein
a backflow prevention mechanism is provided inside the pump.
